(19) United States
(12) Patent Application Publication
(10) Pub. No.: US 2014/0253419 A1
(43) Pub. Date: Sep. 11, 2014

(54) DISPLAY DEVICE AND ELECTRONIC DEVICE

(71) Applicant: SEMICONDUCTOR ENERGY LABORATORY CO., LTD., Atsugi-shi (JP)

(72) Inventor: Yoshifumi TANADA, Takayama (JP)

(73) Assignee: SEMICONDUCTOR ENERGY LABORATORY CO., LTD., Atsugi-shi (JP)

(21) Appl. No.: 14/191,492

(22) Filed: Feb. 27, 2014

(30) Foreign Application Priority Data
Mar. 5, 2013 (JP) 2013-042518

(51) Int. Cl. G09G 3/20

(52) U.S. Cl. CPC G09G 3/2092
USPC 345/55

(57) ABSTRACT

To provide a display device which can achieve a reduced frame width and of which the shape of the frame is the same as or similar to the shape of a display region even in the case where the display region has a non-rectangular shape. The display device includes a non-rectangular display region and a driver circuit portion on the periphery of the display region. The driver circuit portion includes at least two gate drivers and at least two source drivers. One of the gate drivers and the other of the gate drivers are arranged to be apart from each other, and one of the source drivers and the other of the source drivers are arranged to be apart from each other.

### BACKGROUND OF THE INVENTION

1. Field of the Invention

One embodiment of the present invention relates to an object, a method, a manufacturing method, a process, a machine, manufacture, or a composition of matter. In particular, one embodiment of the present invention relates to, for example, a semiconductor device, a display device, a light-emitting device, an electronic device, or a driving method thereof. In particular, one embodiment of the present invention relates to, for example, a display device including a non-rectangular display region. Further, one embodiment of the present invention relates to a driver circuit of a display device including a non-rectangular display region.

Note that the term “display device” means a device including a display element. In addition, the display device also includes a driver circuit for driving a plurality of pixels, and the like. Further, the display device includes a control circuit, a power supply circuit, a signal generation circuit, or the like formed over another substrate.

2. Description of the Related Art

Flat panel displays that are widely used for TVs, portable terminals, and the like are expected to be applied to watches, car electronics, in particular, instrument panels, and the like as new needs.

Since conventional flat panel displays include rectangular display regions, the conventional flat panel displays are compatible with matrix driving in which display regions are controlled row by row or column by column; thus, most of flat panel displays employ matrix driving. On the other hand, in application of displays to watches or car electronics, display regions are required to have a non-rectangular shape in terms of design.

Display devices including non-rectangular display regions are disclosed in Patent Documents 1 to 3 and Non-Patent Document 1, for example.

### REFERENCE

### Patent Document

[Patent Document 1] Japanese Published Patent Application No. 2006-276359
[Patent Document 2] Japanese Published Patent Application No. 2009-69768
[Patent Document 3] Japanese Published Patent Application No. 2007-272203
[Non-Patent Document 1] SID 08 DIGEST pp. 951-954

### SUMMARY OF THE INVENTION

In embodiments disclosed in Patent Documents 1 and 2, signal lines are led toward non-rectangular display regions from a driver circuit provided in any one of the top, bottom, left, and right of the display regions. Therefore, even in the case of a non-rectangular display region, conventional matrix driving can be employed; on the other hand, a region with a certain frame width is required outside the display region. For example, in the case of a circular or elliptical display region, the outside shape of a panel is a quadrangle, an octagon, or the like owing to a region where a driver circuit is arranged and a region where signal lines are lead. In the case of such a method, limitation of housing design becomes serious even if the display region can have a non-rectangular shape.

On the other hand, in embodiments disclosed in Patent Document 3 and Non-Patent Document 1, devising arrangement of driver circuits achieves a reduced frame width along a non-rectangular display region and conventional matrix driving. However, in this method, at least one vertex of the display region is needed between a data driver (source driver) and a gate driver, and thus, the display region is limited. For example, the embodiments cannot be applied to a display region having a shape without vertexes such as a circle or an ellipse or a polygonal shape including a vertex with an obtuse angle much larger than a right angle.

In view of the above problems, an object of one embodiment of the present invention is to provide a display device which can achieve a reduced frame width and of which the shape of the frame is the same as or similar to the shape of a display region even in the case where the display region has a non-rectangular shape. Another object of one embodiment of the present invention is to provide a display device which can achieve a reduced frame width and of which the shape of the frame is the same as or similar to the shape of a display region even in the case where the display region has high design flexibility. Another object of one embodiment of the present invention is to provide driver circuits of a display device which can achieve a reduced frame width and of which the shape of the frame is the same as or similar to the shape of a display region even in the case where the display region has high design flexibility. Another object of one embodiment of the present invention is to provide a display device having a novel structure.

Note that the descriptions of these objects do not disturb the existence of other objects. Note that in one embodiment of the present invention, there is no need to achieve all the objects. Objects other than the above objects will be apparent from and can be derived from the description of the specification, the drawings, the claims, and the like.

A display device of one embodiment of the present invention includes a non-rectangular display region and a driver circuit portion on the periphery of the display region. The driver circuit portion includes at least two gate drivers and at least two source drivers. One of the gate drivers and the other of the gate drivers are arranged to be apart from each other, and one of the source drivers and the other of the source drivers are arranged to be apart from each other.

According to one embodiment of the present invention, a high degree of flexibility of the shape of a display region and minimization of the outside shape of a display device with a reduced frame width can be achieved; thus, a display device with less limitation of design flexibility can be provided.

### BRIEF DESCRIPTION OF THE DRAWINGS

In the accompanying drawings:

FIGS. 1A and 1B are each a schematic top view of a display device;

FIG. 2 is a schematic top view of a display device;

FIG. 3 is a timing chart of a driver circuit portion included in a display device;

FIGS. 4A and 4B are each a timing chart of a driver circuit portion included in a display device;

FIGS. 5A to 5C are each a schematic top view of a display device;

FIGS. 6A to 6D are diagrams of pixel circuits and protection circuits that can be used in a display device; and

FIGS. 7A and 7B are diagrams each illustrating an electronic device.

### DETAILED DESCRIPTION OF THE INVENTION

Hereinafter, embodiments will be described with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

In the drawings, the size, the thickness of layers, and/or regions may be exaggerated for clarity in some cases. Therefore, embodiments of the present invention are not limited to such scales. Note that drawings are schematic views of ideal examples, and the embodiments of the present invention are not limited to the shape or the value illustrated in the drawings. For example, variation in signal, voltage, or current due to noise or difference in timing can be included.

Note that in this specification, ordinal numbers such as “first”, “second”, and “third” are used in order to avoid confusion among components, and the terms do not limit the components numerically.

Note that in this specification, the phrase “A and B are connected” or “A is connected to B” means the case where A and B are electrically connected to each other as well as the case where A and B are directly connected to each other. Here, the description “A and B are electrically connected to each other” or “A is electrically connected to B” means the following case: when an object having any electrical function exists between A and B, an electric signal can be transmitted and received between A and B.

Note that in this specification, terms for describing arrangement, such as “over” “above”, “under”, and “below”, are used for convenience in describing positions of components with reference to drawings. Further, a positional relation between components is changed as appropriate in accordance with a direction in which each component is described. Thus, there is no limitation to terms used in this specification, and description can be made appropriately depending on the situation.

Note that the layout of circuit blocks in a block diagram in a drawing specifies the positional relation for description. Thus, even when a drawing shows that different functions are achieved in different circuit blocks, an actual circuit or region may be configured so that the different functions are achieved in the same circuit or region. Functions of circuit blocks in block diagrams are specified for description, and even in the case where one circuit block is illustrated, blocks may be provided in an actual circuit or region so that processing performed by one circuit block is performed by a plurality of circuit blocks.

### Embodiment 1

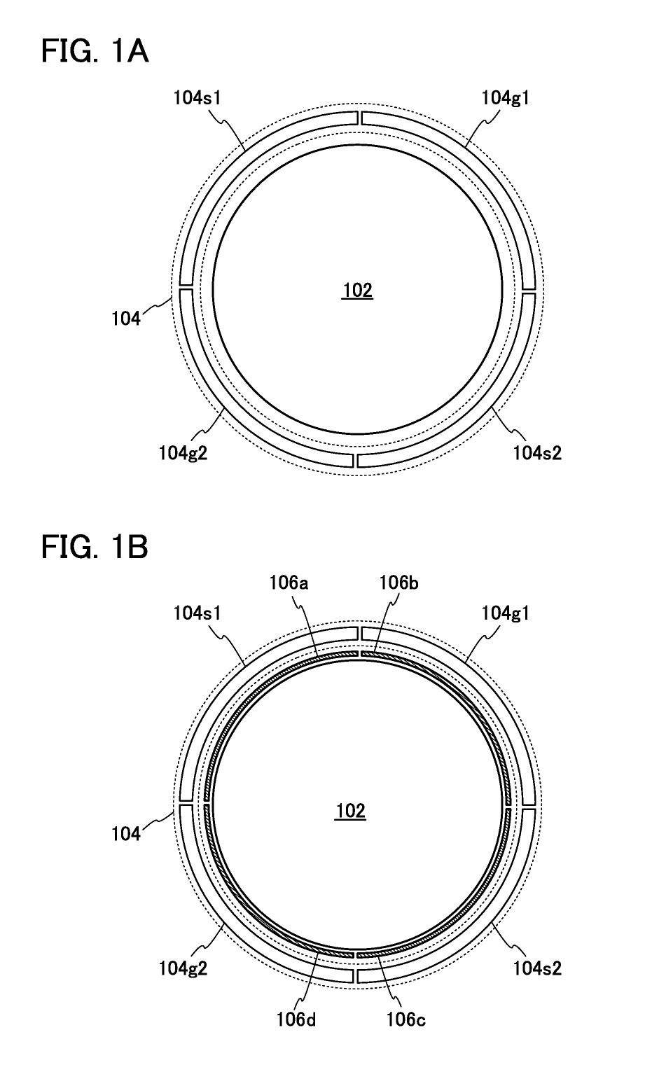

In this embodiment, a display device of one embodiment of the present invention will be described with reference to FIGS. 1A and 1B, FIG. 2, FIG. 3, and FIGS. 4A and 4B.

FIGS. 1A and 1B each illustrate an example of a display device of one embodiment of the present invention. Note that FIGS. 1A and 1B each illustrate the top view of the display device schematically.

The display devices in FIGS. 1A and 1B each include a circular display region. Note that the display region is not limited to a circular shape, and any shape may be used as long as it has a non-rectangular shape. As examples of a non-rectangular shape, a variety of shapes such as a polygonal shape having more than or equal to five corners, a regular circle shape, an oval shape, and a shape including an arc and a straight line can be given.

The display device in FIG. 1A includes a non-rectangular display region 102 and a driver circuit portion 104 on the periphery of the non-rectangular display region 102. The driver circuit portion 104 includes a first gate driver 104g1, a second gate driver 104g2, a first source driver 104s1, and a second source driver 104s2.

The first gate driver 104g1 and the second gate driver 104g2 are arranged to be apart from each other. Further, the first source driver 104s1 and the second source driver 104s2 are arranged to be apart from each other.

As illustrated in FIG. 1A, it is preferable that the first gate driver 104g1 and the second gate driver 104g2 be arranged to face each other. Further, it is preferable that the first source driver 104s1 and the second source driver 104s2 be arranged to face each other. Such arrangement in which the gate drivers or the source drivers face each other enables preferable matrix driving of the non-rectangular display region 102. In particular, in the case where the shape of the non-rectangular display region 102 has a left-right up-down symmetrical structure, a method for arranging parts of driver circuits to face each other is effective.

Although a structure in which a gate driver and a source driver are each divided into two parts is shown in this embodiment, one embodiment of the present invention is not limited thereto. The gate driver and the source driver each may be divided into three or more parts, and in such a case, at least one of a plurality of gate drivers is arranged to be apart from at least another one of the plurality of gate drivers. Alternatively, at least one of a plurality of source drivers is arranged to be apart from at least another one of the plurality of source drivers.

The display device in FIG. 1B is a modification example of the display device in FIG. 1A, and protection circuits 106a, 106b, 106c, and 106d are arranged between the non-rectangular display region 102 and the driver circuit portion 104 on the periphery of the non-rectangular display region 102. In FIG. 1B, the protection circuit 106a has a function of protecting the first source driver 104s1 that is a driver circuit, the protection circuit 106b has a function of protecting the first gate driver 104g1 that is a driver circuit, the protection circuit 106c has a function of protecting the second source driver 104s2 that is a driver circuit, and the protection circuit 106d has a function of protecting the second gate driver 104g2 that is a driver circuit.

The structure of the protection circuit is not limited to the above structure, and for example, at least one of the first gate driver 104g1, the second gate driver 104g2, the first source driver 104s1, and the second source driver 104s2 is preferably provided with the protection circuit.

Here, the case where the display regions illustrated in FIGS. 1A and 1B are controlled by matrix driving is described below.

In one embodiment of the present invention illustrated in FIGS. 1A and 1B, the outer edge of the display region 102, that is, the arc thereof, is divided into a plurality of parts, and driver circuits (gate drivers and/or source drivers) are arranged on the periphery of the respective divided outer edges; thus, the display region can be preferably controlled by matrix driving.

In the case of the circular display region illustrated in FIGS. 1A and 1B, the arc thereof is divided into four parts, for example. In the case where the display region 102 is seen from a given direction that is set as a regular position, the display region 102 is divided into four regions, an upper right portion, a lower right portion, an upper left portion, and a lower left portion.

In FIGS. 1 A and 1B, a driver circuit (the first gate driver 104g1) which controls scan lines in the horizontal direction is arranged on the upper right side, and a driver circuit (the second gate driver 104g2) which controls scan lines in the horizontal direction is arranged on the lower left side. Further, a driver circuit (the first source driver 104s1) which controls signal lines in the vertical direction is arranged on the upper left side, and a driver circuit (the second source driver 104s2) which controls signal lines in the vertical direction is arranged on the lower right side.

With such arrangement, for example, the first gate driver 104g1 on the upper right side selects rows in the upper half of the screen, and the second gate driver 104g2 on the lower left side selects rows in the lower half of the screen. The first source driver 104s1 on the upper left side inputs signals to the left half of the screen, and the second source driver 104s2 on the lower right side inputs signals to the right half of the screen.

Such arrangement and control method of driver circuits can solve the following problems.

In the case where a display device including a non-rectangular display region, for example, a circular display region is controlled by matrix driving, driver circuits are necessarily provided to select and control all the rows and all the columns of the display region by a conventional control method. In other words, in the case of a circular display region, the source driver and the gate driver are each necessarily arranged along at least any half of the circumference. In the case where the source driver is provided along a half of the circumference and the gate driver is provided along the other half of the circumference, for example, the drivers cannot be provided so that the scan direction is the straight direction or the direction similar to the straight direction; thus, the drivers are necessarily arranged linearly in a region apart from the outer edge of the display region.

In the case where the drivers are arranged in a region apart from the outer edge of the display region as described above, the driver circuit cannot be arranged on the periphery of the display region, and as a result, it is difficult to achieve minimization of the outside shape of the display device with a reduced frame width. However, as illustrated in FIGS. 1A and 1B, the outer edge of the display region, that is, the arc thereof, is divided into a plurality of parts, and driver circuits are provided on the periphery of the respective divided outer edges, resulting in achievement of minimization of the outside shape of the display device with a reduced frame width.

Components of the display devices illustrated in FIGS. 1A and 1B will be described below in detail.

### <Display Region>

The display region 102 includes circuits (also referred to as pixel circuit portions) for driving a plurality of display elements arranged in X rows (X is a natural number of 2 or more) and Y columns (Y is a natural number of 2 or more). The pixel circuit portion is supplied with a pulse signal through one of a plurality of scan lines to which a scan signal is supplied and with a data signal through one of a plurality of signal lines to which a data signal is supplied. Further, writing and holding of the data signal in the pixel circuit portion are performed by the gate driver. For example, the pixel circuit portion is supplied with a pulse signal from a gate driver through a scan line and with a data signal from a source driver through a signal line in accordance with a potential of the scan line.

### <Driver Circuit Portion>

The driver circuit portion 104 includes driver circuits such as a circuit (also referred to as a gate driver) which outputs a signal (scan signal) for selecting a pixel circuit portion included in the display region 102 and a circuit (also referred to as a source driver) which supplies a signal (data signal) for driving a display element of a pixel circuit portion included in the display region 102. Part or all of the driver circuit portion 104 is preferably formed over the same substrate as the display region 102. Thus, the number of components and the number of terminals can be reduced. The structure of the driver circuit portion 104 is not limited thereto, and for example, the driver circuit portion 104 is not necessarily formed over the same substrate as the display region 102. In that case, part of the driver circuit portion 104 can be mounted by a COG method or a TAB method.

### <Gate Driver>

The first gate driver 104g1 and the second gate driver 104g2 each include a shift register or the like, for example. The first gate driver 104g1 and the second gate driver 104g2 each receive a signal for driving the shift register and output a signal. For example, the first gate driver 104g1 and the second gate driver 104g2 each receive a start pulse signal, a clock signal, or the like and output a pulse signal. Further, the first gate driver 104g1 and the second gate driver 104g2 each have a function of controlling a potential of a wiring to which a scan signal is supplied. Alternatively, the first gate driver 104g1 and the second gate driver 104g2 each have a function of supplying an initialization signal. Note that without limitation thereto, the first gate driver 104g1 and the second gate driver 104g2 each can supply another signal.

### <Source Driver>

The first source driver 104s1 and the second source driver 104s2 each include a shift register or the like. The first source driver 104s1 and the second source driver 104s2 each receive a signal (image signal) from which a data signal is derived, as well as a signal for driving the shift register. The first source driver 104s1 and the second source driver 104s2 each have a function of generating a data signal to be written to the pixel circuit portion included in the display region 102 on the basis of the image signal. Further, the first source driver 104s1 and the second source driver 104s2 each have a function of controlling output of a data signal in accordance with a pulse signal produced by input of a start pulse signal, a clock signal, or the like. In addition, the first source driver 104s1 and the second source driver 104s2 each have a function of controlling a potential of a wiring to which a data signal is supplied. Alternatively, the first source driver 104s1 and the second source driver 104s2 each have a function of supplying an initialization signal. Note that without limitation thereto, the first source driver 104s1 and the second source driver 104s2 each can supply another signal.

The first source driver 104s1 and the second source driver 104s2 include a plurality of analog switches and the like, for example. By sequentially turning on the plurality of analog switches, the first source driver 104s1 and the second source driver 104s2 each can output, as the data signals, signals obtained by time-dividing the image signal. Further, the first source driver 104s1 and the second source driver 104s2 each may include a shift register and the like.

### <Protection Circuit>

The protection circuits 106a, 106b, 106c, and 106d are connected to, for example, a scan line that is a wiring between the first gate driver 104g1 and/or the second gate driver 104g2 and the pixel circuit portion of the display region 102. Alternatively, the protection circuits 106a, 106b, 106c, and 106d are connected to a signal line that is a wiring between the first source driver 104s1 and/or the second source driver 104s2 and the pixel circuit portion of the display region 102. The protection circuits 106a, 106b, 106c, and 106d are each a circuit which electrically connects a wiring connected to the protection circuit to another wiring when a potential out of a certain range is supplied to the wiring connected to the protection circuit.

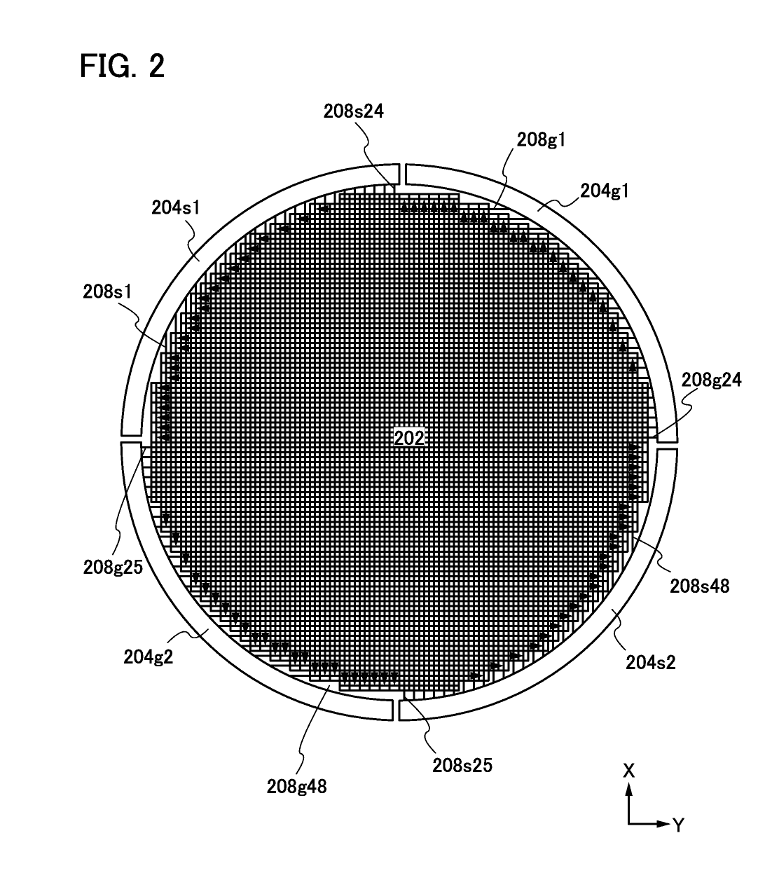

Next, FIG. 2 illustrates a more specific example of the display device in FIG. 1A. FIG. 2 is a schematic top view of the display device.

In the display device in FIG. 2, the display region is a circle and the number of pixels in the diameter direction is 48 dots.

Further, the display device in FIG. 2 includes a non-rectangular display region 202, a first gate driver 204g1 arranged along part of the outer edge of the non-rectangular display region 202, a second gate driver 204g2 arranged along part of the outer edge of the non-rectangular display region 202, a first source driver 204s1 arranged along part of the outer edge of the non-rectangular display region 202, and a second source driver 204s2 arranged along part of the outer edge of the non-rectangular display region 202.

The first gate driver 204g1 is connected to a first scan line 208g1 to a twenty-fourth scan line 208g24. The second gate driver 204g2 is connected to a twenty-fifth scan line 208g25 to a forty-eighth scan line 208g48. The first source driver 204s1 is connected to a first signal line 208s1 to a twenty-fourth signal line 208s24. The second source driver 204s2 is connected to a twenty-fifth signal line 208s25 to a forty-eighth signal line 208s48.

In FIG. 2, the X direction indicates a direction of the scan lines (the first scan line 208g1 to the forty-eighth scan line 208g48), and the Y direction indicates a direction of the signal lines (the first signal line 208s1 to the forty-eighth signal line 208s48). In FIG. 2, the reference numerals of the second scan line 208g2 to the twenty-third scan line 208g23, the twenty-sixth scan line 208g26 to the forty-seventh scan line 208g47, the second signal line 208s2 to the twenty-third signal line 208s23, and the twenty-sixth signal line 208s26 to the forty-seventh scan line 208s47 are omitted for simplicity.

Directions of arrows in FIG. 2 each indicate a direction in which a scan line or a signal line connected to the driver circuit (the first gate driver 204g1, the second gate driver 204g2, the first source driver 204s1, or the second source driver 204s2) is extended.

In FIG. 2, a pixel arranged in a circumferential portion of the circular display region has a quadrangular shape, and the circumferential portion has a step-like shape based on dots in this case. Further, in the case where the image quality of the circumferential portion of the display region is needed to be increased, the shape of the pixel electrode of the pixel arranged in the circumferential portion of the display region may be a shape including an arc on one side or two sides in accordance with the shape of the circumferential portion of the display region, and arcs of the pixels may be connected on the outer edge of the display region to form the circumferential portion.

As illustrated in FIG. 2, the first gate driver 204g1 can control the scan lines in the upper half of the non-rectangular display region 202. The second gate driver 204g2 can control the scan lines in the lower half of the non-rectangular display region 202. The first source driver 204s1 can control the signal lines in the left half of the non-rectangular display region 202. The second source driver 204s2 can control the signal lines in the right half of the non-rectangular display region 202.

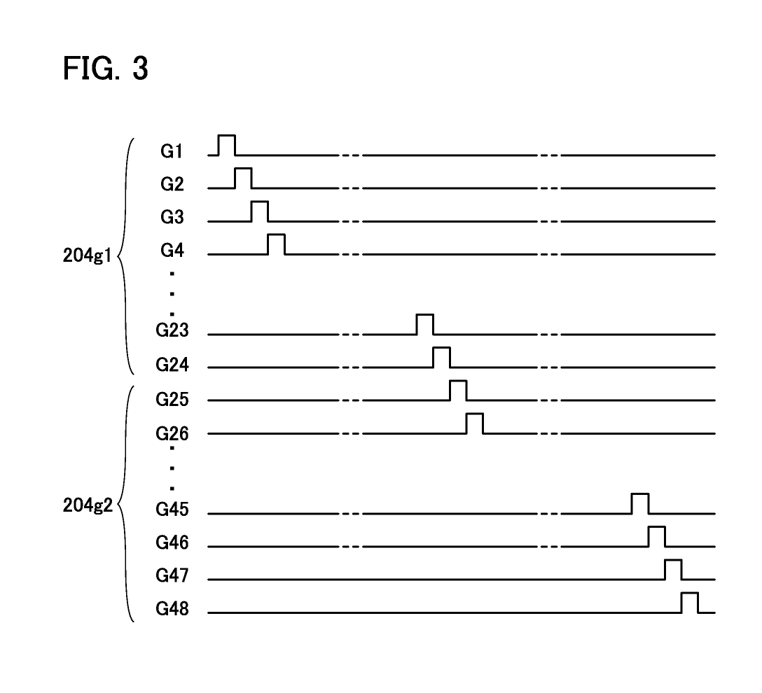

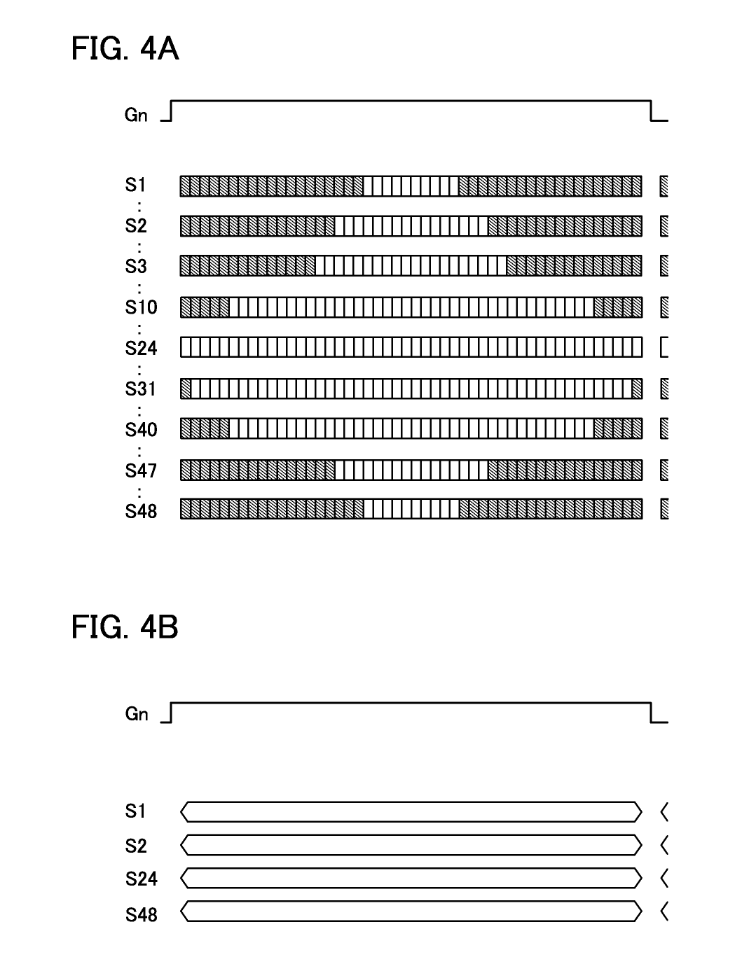

Here, timing charts relating to writing of the display device in FIG. 2 are shown in FIG. 3 and FIGS. 4A and 4B.

In the timing chart in FIG. 3, a scan signal input to the first scan line 208g1 (G1) to a scan signal input to the twenty-fourth scan line 208g24 (G24) are controlled by the first gate driver 204g1, and a scan signal input to the twenty-fifth scan line 208g25 (G25) and scan signals input to the scan lines after the twenty-fifth line 208g25 are controlled by the second gate driver 204g2. A timing signal is controlled so that the scan signal input to the twenty-fourth scan line 208g24 (G24) is controlled by the first gate driver 204g1 subsequently the scan signal input to the twenty-fifth scan line 208g25 (G25) is controlled by the second gate driver 204g2.

When the operation start timing of each gate driver is controlled, as described above, so that pulse output from the first gate driver 204g1 on the upper right side of the display device in FIG. 2 and pulse output from the second gate driver 204g2 on the lower left side are continuously performed, the display region can be continuously scanned from the top to the bottom.

Further, as a driving method of the first source driver 204s1 and the second source driver 204s2, line sequential driving or dot sequential driving may be employed in a selection period during which a row is selected.

In the case of dot sequential driving, for example, as illustrated in FIG. 4A, data signals may be input to desired signal lines (data signals S1 to S48 input to the first signal line 208s1 to the forty-eighth signal line 208s48 in FIG. 4A) in a period during which a desired scan line (an n-th scan line 208gn in FIG. 4A) is selected. Note that in the timing chart in FIG. 4A, a hatching region shows a state where a data signal is not output to a signal line and a white region shows a state where a desired data signal is output to a signal line.

In the case of line sequential driving, for example, as illustrated in FIG. 4B, data signals (S1 to S48 in FIG. 4B) are output at the same timing to all signal lines in a period during which a desired scan line (an n-th scan line 208gn in FIG. 4B) is selected.

As described above, in the display device in this embodiment, a gate driver and a source driver which are driver circuit portions for a non-rectangular display region are each divided and arranged to be apart from each other, preferably arranged to face each other, which enables the non-rectangular display region to be controlled by matrix driving. Accordingly, a high degree of flexibility of the shape of the display region and minimization of the outside shape of the display device with a reduced frame width can be achieved, whereby a display device with less limitation of design flexibility can be provided.

The structure described in this embodiment can be used in appropriate combination with the structure described in any of the other embodiments.

### Embodiment 2

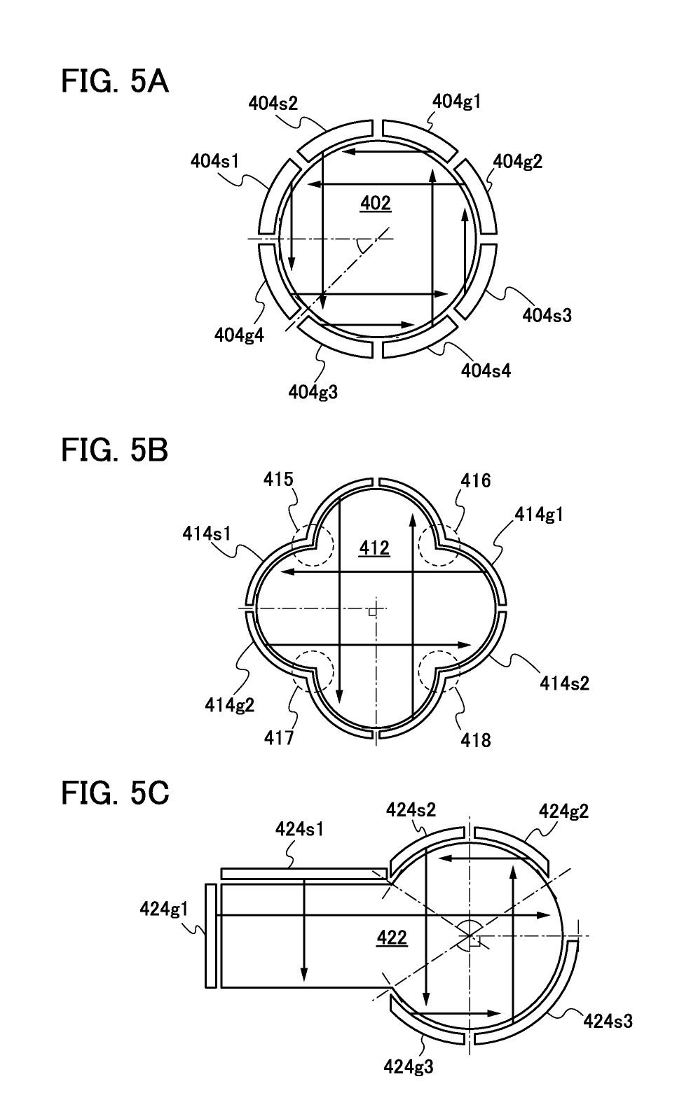

In this embodiment, structures of display devices which are different from those described in Embodiment 1 will be described with reference to FIGS. 5A to 5C.

FIGS. 5A to 5C are schematic top views each illustrating a display device of one embodiment of the present invention.

Note that in FIGS. 5A to 5C, directions of arrows in the diagrams each indicate a direction in which a scan line or a signal line which is connected to a driver circuit is controlled.

The display device in FIG. 5A, which is a modification example of the display device in FIG. 1A, includes a non-rectangular display region 402 and a driver circuit portion on the periphery of the non-rectangular display region 402. The driver circuit portion includes a first gate driver 404g1, a second gate driver 404g2, a third gate driver 404g3, a fourth gate driver 404g4, a first source driver 404s1, a second source driver 404s2, a third source driver 404s3, and a fourth source driver 404s4.

Note that the first gate driver 404g1 is arranged to be apart from the third gate driver 404g3 and/or the fourth gate driver 404g4. The second gate driver 404g2 is arranged to be apart from the third gate driver 404g3 and/or the fourth gate driver 404g4. The first source driver 404s1 is arranged to be apart from the third source driver 404s3 and/or the fourth source driver 404s4. The second source driver 404s2 is arranged to be apart from the third source driver 404s3 and/or the fourth source driver 404s4.

The display device in FIG. 5A includes three or more gate drivers and three or more source drivers. In such a case, the gate driver and at least one of the other gate drivers are arranged to be apart from each other. The source driver and at least one of the other source drivers are arranged to be apart from each other.

In FIG. 5A, driver circuits (the first gate driver 404g1 and the second gate driver 404g2) which control scan lines in the horizontal direction are arranged on the upper right side, driver circuits (the third gate driver 404g3 and the fourth gate driver 404g4) which control scan lines in the horizontal direction are arranged on the lower left side, driver circuits (the first source driver 404s1 and the second source driver 404s2) which control signal lines in the vertical direction are arranged on the upper left side, and driver circuits (the third source driver 404s3 and the fourth source driver 404s4) which control the signal lines in the vertical direction are arranged on the lower right side.

With such arrangement, for example, the first gate driver 404g1 and the second gate driver 404g2 on the upper right side select rows in the upper half of the screen, and the third gate driver 404g3 and the fourth gate driver 404g4 on the lower left side select rows in the lower half of the screen. The first source driver 404s1 and the second source driver 404s2 on the upper left side input signals to the left half of the screen, and the third source driver 404s3 and the fourth source driver 404s4 on the lower right side input signals to the right half of the screen.

As a method for arranging driver circuits of the display device in FIG. 5A, for example, the fourth gate driver 404g4 is arranged along one-eighth of an arc (lower left portion) of the display region 402. Further, an angle between normals of both ends of the arc of the display region 402 which corresponds to a position of the fourth gate driver 404g4 is 45°.

The display device in FIG. 5B is a structure example of the case where the display region has a so-called flower shape. The display device in FIG. 5B includes a non-rectangular display region 412 and a driver circuit portion on the periphery of the non-rectangular display region 412. The driver circuit portion includes a first gate driver 414g1, a second gate driver 414g2, a first source driver 414s1, and a second source driver 414s2.

The first gate driver 414g1 and the second gate driver 414g2 are arranged to be apart from each other. Further, the first source driver 414s1 and the second source driver 414s2 are arranged to be apart from each other.

In the display device in FIG. 5B, the display region has inwardly dented shapes at regions 415, 416, 417, and 418, compared with the display device in FIG. 1A; however, a method of dividing a driver circuit portion may be similar to that in FIG. 1A.

As a method for arranging driver circuits of the display device in FIG. 5B, for example, the second gate driver 414g2 is arranged along one-fourth of the outer edge (lower left portion) of the display region 412. Further, an angle between normals of both ends of part of the outer edge of the display region 412 which corresponds to a position of the second gate driver 414g2 is 90°.

The display device in FIG. 5C, which is a structure example of a more complicated shape of a display region than those in FIGS. 5A and 5B. The display device in FIG. 5C includes a non-rectangular display region 422 and a driver circuit portion on the periphery of the non-rectangular display region 422. The driver circuit portion includes a first gate driver 424g1, a second gate driver 424g2, a third gate driver 424g3, a first source driver 424s1, a second source driver 424s2, and a third source driver 424s3.

The first gate driver 424g1, the second gate driver 424g2, and the third gate driver 424g3 are arranged to be apart from one another. The first source driver 424s1 and the third source driver 424s3 are arranged to be apart from each other. The second source driver 424s2 and the third source driver 424s3 are arranged to be apart from each other.

In FIG. 5C, the driver circuit (the first gate driver 424g1) which controls scan lines in the horizontal direction is arranged on a short side of a rectangle part of the display region, the driver circuit (the second gate driver 424g2) which controls scan lines in the horizontal direction is arranged on the upper right side of a circle part of the display region, the driver circuit (the third gate driver 424g3) which controls scan lines in the horizontal direction is arranged on the lower left side of the circle part of the display region, the driver circuit (the first source driver 424s1) which controls signal lines in the vertical direction is arranged on a long side of the rectangle part of the display region, the driver circuit (the second source driver 424s2) which controls signal lines in the vertical direction is arranged on the upper left side of the circle part of the display region, and the driver circuit (the third source driver 424s3) which controls signal lines in the vertical direction is arranged on the lower right side of the circle part of the display region.

With such arrangement, for example, the first gate driver 424g1 selects rows in the middle part of the screen, the second gate driver 424g2 selects rows in the upper part of the screen, and the third gate driver 424g3 selects rows in the lower part of the screen. The first source driver 424s1 inputs signals to the left part of the screen, the second source driver 424s2 inputs signals to the middle part of the screen, and the third source driver 424s3 inputs signals to the right part of the screen.

As a method for arranging driver circuits of the display device in FIG. 5C, for example, the third source driver 424s3 is arranged along one-fourth of an arc (lower right portion) of part of the display region 422. Further, an angle between normals of both ends of the arc of the display region 422 which corresponds to a position of the third source driver 424s3 is 90°. The second source driver 424s2, the second gate driver 424g2, and the third gate driver 424g3 are arranged in part of the upper left portion, part of the upper right portion, and part of the lower left portion, respectively, of the arc partly included in the display region 422. Further, an angle between normals of both ends of respective arcs of the display region 422 which correspond to positions of the second source driver 424s2, the second gate driver 424g2, and the third gate driver 424g3 is smaller than 90°.

The display device in FIG. 5C can be applied to instrument panels and the like of cars or motorcycles, for example.

The method for arranging driver circuits of the display region similar to that of the circular display region described in FIGS. 1A and 1B in Embodiment 1 can also be applied to the display region of which the shape is not a circular shape as illustrated in FIGS. 5B and 5C. Specifically, the outer edge of the display region is divided into a plurality of parts with any point on the outer edge of the display region as the reference, and driver circuits are arranged on the periphery of the divided outer edges.

In the case where the outer edge of the display region is divided into a plurality of parts, one embodiment of the present invention can be applied as long as divided points can be determined so that each of angles between normals of both ends of parts to be divided is not larger than a right angle or is not greatly smaller or larger than a right angle.

As described above, one embodiment of the present invention can be applied to a display device including the circular display region illustrated in FIG. 5A, the so-called flower-shaped display region illustrated in FIG. 5B, or the display region which is formed of a straight line and an arc illustrated in FIG. 5C.

As described above, in the display device in this embodiment, a gate driver and a source driver which are driver circuit portions for a non-rectangular display region are each divided and arranged to be apart from each other, which enables the non-rectangular display region to be controlled by matrix driving. Accordingly, a high degree of flexibility of the shape of the display region and minimization of the outside shape of the display device with a reduced frame width can be achieved, whereby a display device with less limitation of design flexibility can be provided.

The structure described in this embodiment can be used in appropriate combination with the structure described in any of the other embodiments.

### Embodiment 3

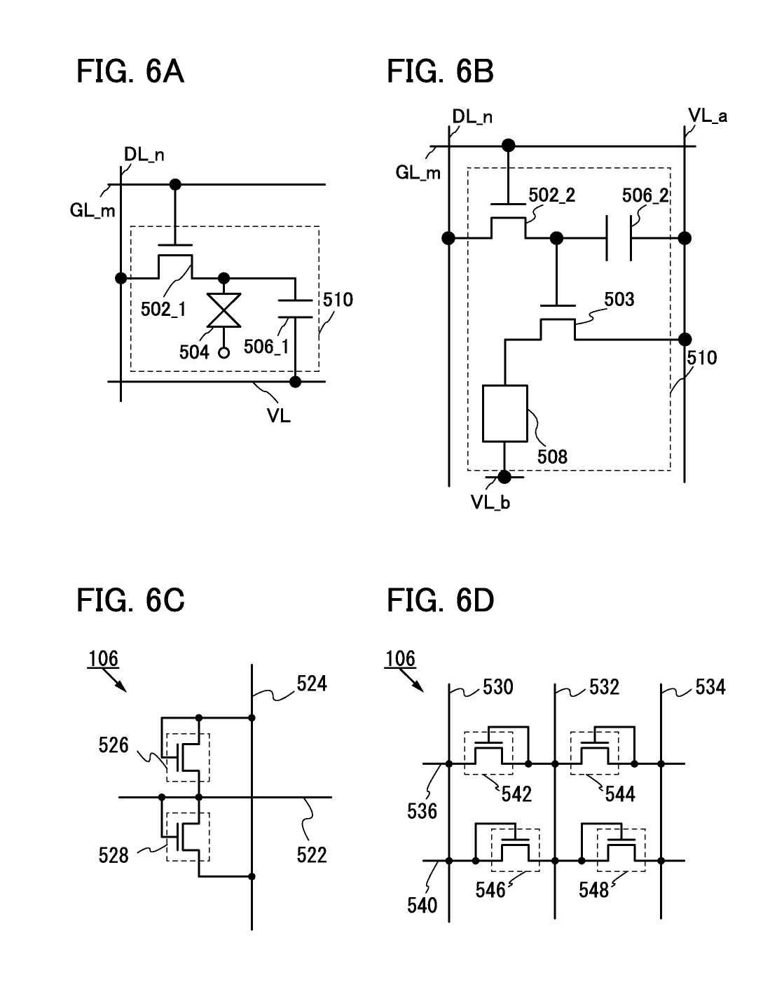

In this embodiment, a circuit configuration which can be used for a pixel circuit portion included in the display region 102 in FIG. 1A is described with reference to FIGS. 6A and 6B. Then, a circuit configuration which can be used for the protection circuits 106a, 106b, 106c, and 106d in FIG. 1B is described with reference to FIGS. 6C and 6D. Note that common reference numerals are used for portions having functions similar to those in the above embodiments, and detailed description of the portions is omitted.

First, circuit configurations in FIGS. 6A and 6B are described below.

A pixel circuit portion 510 in FIG. 6A includes a liquid crystal element 504, a transistor 502_1, and a capacitor 506_1.

As the transistor 502_1, a thin film transistor (TFT) formed over a glass substrate or a plastic substrate can be used, for example. Either a staggered TFT or an inverted staggered TFT may be employed. As a semiconductor material used for the TFT, amorphous silicon, polycrystalline silicon, single crystal silicon, or the like can be used. Alternatively, an oxide semiconductor may be used. The oxide semiconductor preferably includes a layer represented by an In-M-Zn oxide containing at least indium (In), zinc (Zn), and M (M is a metal such as Al, Ga, Ge, Y, Zr, Sn, La, Ce, or HO. Alternatively, both In and Zn are preferably contained. In order to reduce fluctuations in electrical characteristics of the transistors including the oxide semiconductor, the oxide semiconductor preferably contains a stabilizer in addition to In and Zn.

In addition, a driver circuit formed over a TFT substrate may be formed with an n-type TFT and a p-type TFT, or with either an n-type TFT or a p-type TFT.

The potential of one of a pair of electrodes of the liquid crystal element 504 is set in accordance with the specifications of the pixel circuit portion 510 as appropriate. The alignment state of the liquid crystal element 504 depends on written data. A common potential may be supplied to one of the pair of electrodes of the liquid crystal element 504 included in each of a plurality of pixel circuit portions 510. Further, the potential supplied to one of a pair of electrodes of the liquid crystal element 504 in the pixel circuit portion 510 in one row may be different from the potential supplied to one of a pair of electrodes of the liquid crystal element 504 in the pixel circuit portion 510 in another row.

As examples of a driving method of the display device including the liquid crystal element 504, any of the following modes can be given: a TN mode, an STN mode, a VA mode, an axially symmetric aligned micro-cell (ASM) mode, an optically compensated birefringence (OCB) mode, a ferroelectric liquid crystal (FLC) mode, an antiferroelectric liquid crystal (AFLC) mode, an MVA mode, a patterned vertical alignment (PVA) mode, an IPS mode, an FFS mode, a transverse bend alignment (TBA) mode, and the like. Other examples of the driving method of the display device include an electrically controlled birefringence (ECB) mode, a polymer dispersed liquid crystal (PDLC) mode, a polymer network liquid crystal (PNLC) mode, and a guest-host mode. Note that the present invention is not limited to these examples, and a variety of liquid crystal elements and driving methods can be applied to the liquid crystal element and the driving method thereof.

The liquid crystal element may be formed using a liquid crystal composition including liquid crystal exhibiting a blue phase and a chiral material. The liquid crystal exhibiting a blue phase has a short response time of 1 msec or less and is optically isotropic; therefore, alignment treatment is not necessary and viewing angle dependence is small.

In the pixel circuit portion 510 in the m-th row and the n-th column (m and n are each a natural number of 2 or more), one of a source and a drain of the transistor 502_1 is electrically connected to a signal line DL_n, and the other is electrically connected to the other of a pair of electrodes of the liquid crystal element 504. A gate of the transistor 502_1 is electrically connected to a scan line GL_m. The transistor 502_1 has a function of controlling whether to write a data signal by being turned on or off.

One of a pair of electrodes of the capacitor 506_1 is electrically connected to a wiring to which a potential is supplied (hereinafter referred to as a potential supply line VL), and the other is electrically connected to the other of the pair of electrodes of the liquid crystal element 504. The potential of the potential supply line VL is set in accordance with the specifications of the pixel circuit portion 510 as appropriate. The capacitor 506_1 functions as a storage capacitor for storing written data.

For example, in the display device including the pixel circuit portion 510 in FIG. 6A, the pixel circuit portions 510 are sequentially selected row by row by the first gate driver 104g1 and/or the second gate driver 104g2, whereby the transistors 502_1 are turned on and a data signal is written.

When the transistors 502_1 are turned off, the pixel circuit portions 510 in which the data has been written are brought into a holding state. This operation is sequentially performed row by row; thus, an image is displayed.

The pixel circuit portion 510 in FIG. 6B includes a transistor 502_2, a capacitor 506_2, a transistor 503, and a light-emitting element 508.

One of a source and a drain of the transistor 502_2 is electrically connected to the signal line DL_n. A gate of the transistor 502_2 is electrically connected to the scan line GL_m.

The transistor 502_2 has a function of controlling whether to write a data signal by being turned on or off.

One of a pair of electrodes of the capacitor 506_2 is electrically connected to a wiring to which power is supplied (power supply line VL_a), and the other is electrically connected to a gate of the transistor 503. The position of the capacitor 506_2 is not limited thereto depending on the polarity of the TFT as long as the gate-source voltage of the transistor 503 can be preferably held.

The capacitor 506_2 functions as a storage capacitor for storing written data.

One of a source and a drain of the transistor 503 is electrically connected to the power supply line VL_a. Further, a gate of the transistor 503 is electrically connected to the other of the source and the drain of the transistor 502_2.

One of an anode and a cathode of the light-emitting element 508 is electrically connected to a power supply line VL b, and the other is electrically connected to the other of the source and the drain of the transistor 503.

As the light-emitting element 508, an organic electroluminescent element (also referred to as an organic EL element) or the like can be used, for example. Note that the light-emitting element 508 is not limited to organic EL elements; an inorganic EL element including an inorganic material can be used.

A high power supply potential VDD is supplied to one of the power supply line VL_a and the power supply line VL_b, and a low power supply potential VSS is supplied to the other. In this case, in the light-emitting element 508, current flows from the power supply line VL_a to the power supply line VL_b; however, a power supply potential is supplied in some cases so that current flows in the opposite direction.

In the display device including the pixel circuit portion 510 in FIG. 6B, the pixel circuit portions 510 are sequentially selected row by row by the first gate driver 104g1 and/or the second gate driver 104g2, whereby the transistors 502_2 are turned on and a data signal is written.

When the transistors 502_2 are turned off, the pixel circuit portions 510 in which the data has been written are brought into a holding state. Further, the amount of current flowing between the source and the drain of the transistor 503 is controlled in accordance with the potential of the written data signal. The light-emitting element 508 emits light with a luminance corresponding to the amount of flowing current. This operation is sequentially performed row by row; thus, an image is displayed.

Note that in this specification and the like, a display element, a display device which is a device including a display element, a light-emitting element, and a light-emitting device which is a device including a light-emitting element can employ a variety of modes or can include a variety of elements. Examples of a display element, a display device, a light-emitting element, or a light-emitting device include an EL (electroluminescent) element (e.g., an EL element including organic and inorganic materials, an organic EL element, or an inorganic EL element), an LED (e.g., a white LED, a red LED, a green LED, or a blue LED), a transistor (a transistor which emits light depending on current), an electron emitter, a liquid crystal element, electronic ink, an electrophoretic element, a grating light valve (GLV), a plasma display panel (PDP), a display device using a micro electro mechanical system (MEMS), a digital micromirror device (DMD), a digital micro shutter (DMS), MIRASOL (registered trademark), an interferometic modulator display (IMOD), a piezoelectric ceramic display, or a carbon nanotube, which are display media whose contrast, luminance, reflectivity, transmittance, or the like is changed by electromagnetic action. Note that examples of a display device having an EL element include an EL display and the like. Examples of a display device having an electron emitter include a field emission display (FED), an SED-type flat panel display (SED: surface-conduction electron-emitter display), and the like. Examples of a display device having a liquid crystal element include a liquid crystal display (e.g., a transmissive liquid crystal display, a transflective liquid crystal display, a reflective liquid crystal display, a direct-view liquid crystal display, or a projection liquid crystal display) and the like. Examples of a display device having electronic ink or electrophoretic elements include electronic paper.

Examples of an EL element are an element including an anode, a cathode, and an EL layer interposed between the anode and the cathode, and the like. Examples of an EL layer include, but are not limited to, a layer utilizing light emission (fluorescence) from a singlet exciton, a layer utilizing light emission (phosphorescence) from a triplet exciton, a layer utilizing light emission (fluorescence) from a singlet exciton and light emission (phosphorescence) from a triplet exciton, a layer including an organic material, a layer including an inorganic material, a layer including an organic material and an inorganic material, a layer including a high-molecular material, a layer including a low-molecular material, a layer including a high-molecular material and a low-molecular material, and the like. Further, a variety of types of EL elements can be used as well as these examples.

An example of liquid crystal elements is an element where transmission and non-transmission of light is controlled by optical modulation action of liquid crystals. The element can be configured to include a pair of electrodes and a liquid crystal layer. The optical modulation action of liquid crystal is controlled by an electric field applied to the liquid crystal (including a lateral electric field, a vertical electric field, and a diagonal electric field). Note that specifically, the following can be used for a liquid crystal element: a nematic liquid crystal, a cholesteric liquid crystal, a smectic liquid crystal, a discotic liquid crystal, a thermotropic liquid crystal, a lyotropic liquid crystal, a low-molecular liquid crystal, a high-molecular liquid crystal, a polymer dispersed liquid crystal (PDLC), a ferroelectric liquid crystal, an anti-ferroelectric liquid crystal, a main-chain liquid crystal, a side-chain high-molecular liquid crystal, a banana-shaped liquid crystal, and the like.

For example, display of electronic paper can be performed using molecules (a method utilizing optical anisotropy, dye molecular orientation, or the like), particles (a method utilizing electrophoresis, particle movement, particle rotation, phase change, or the like), movement of one end of a film, coloring properties or phase change of molecules, optical absorption by molecules, or self-light emission by combination of electrons and holes. Specifically, examples of a display method of electronic paper are microcapsule electrophoresis, horizontal electrophoresis, vertical electrophoresis, a spherical twisting ball, a magnetic twisting ball, a columnar twisting ball, a charged toner, an electronic liquid powder, magnetic electrophoresis, a magnetic thermosensitive type, electro wetting, light-scattering (transparent-opaque change), a cholesteric liquid crystal and a photoconductive layer, a cholesteric liquid crystal, a bistable nematic liquid crystal, a ferroelectric liquid crystal, a liquid crystal dispersed type with a dichroic dye, a movable film, coloring and decoloring properties of a leuco dye, photochromism, electrochromism, electrodeposition, flexible organic EL, and the like. Note that the present invention is not limited to these examples, and a variety of electronic paper and display methods can be used as electronic paper and a display method thereof. Here, with the use of microcapsule electrophoresis, aggregation and precipitation of phoresis particles can be prevented. An electronic liquid powder has advantages such as high-speed response, high reflectivity, wide viewing angle, low power consumption, and memory properties.

Next, circuit configurations in FIGS. 6C and 6D are described.

In a protection circuit 106 illustrated in FIG. 6C, diode-connected transistors 526 and 528 are connected to a wiring 522 and a wiring 524. The wiring 522 is a wiring for connecting a scan line or a signal line, for example.

The wiring 522 is, for example, a wiring to which the potential (VDD, VSS, or GND) of a power supply line for supplying power to the first gate driver 104g1 and/or the second gate driver 104g2 in FIG. 1A is supplied. Alternatively, the wiring 522 is a wiring to which a common potential is supplied (common line). For example, the wiring 522 is preferably connected to the power supply line for supplying power to the first gate driver 104g1 and/or the second gate driver 104g2, in particular, to a wiring for supplying a low potential.

In the protection circuit 106 illustrated in FIG. 6D, diode-connected transistors 542, 544, 546, and 548 are connected to wirings 530, 532, 534, 536, and 540. The wirings 530, 532, and 534 are signal lines DL, for example.

By the protection circuit 106 included in the display device, the display region 102 and the driver circuit portion 104 can have an enhanced resistance to overcurrent due to electro static discharge (ESD) or the like.

The structure described in this embodiment can be used in appropriate combination with the structure described in any of the other embodiments.

### Embodiment 4

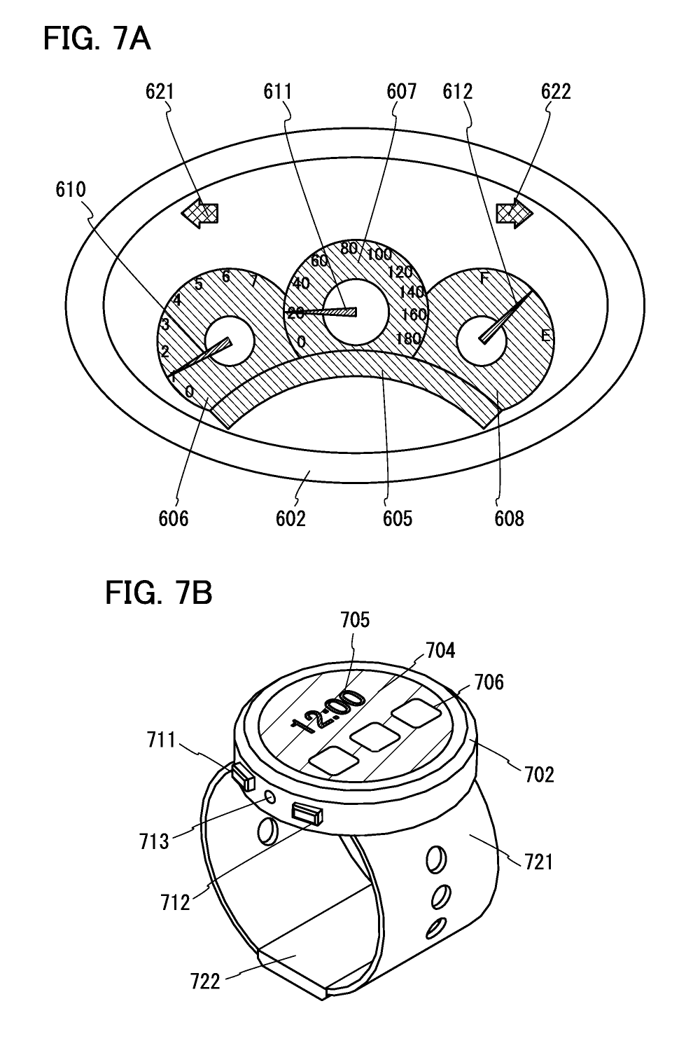

In this embodiment, examples of electronic devices including the display devices illustrated in Embodiments 1 to 3 are described with reference to FIGS. 7A and 7B.

FIG. 7A illustrates an instrument panel of a motorcycle or a car. The instrument panel can include a housing 602, display panels 605, 606, 607, and 608, needles 610, 611, and 612, indicators 621 and 622, and the like.

The display panels 605, 606, 607, and 608 each include a non-rectangular display region. Although a structure in which the display panels 605, 606, 607, and 608 are apart from one another is described in this embodiment, the structure is not limited thereto. For example, a structure in which the display panels 605, 606, 607, and 608 are formed integrally may be employed.

The display panels 605, 606, 607, and 608 can display information of a speed meter, a tachometer, a fuel meter, a water temperature meter, a mileage meter, and the like which is necessary for driving a motorcycle or a car.

Further, the indicators 621 and 622 are provided to recognize the operation of a direction indicator, and a display device of one embodiment of the present invention can also be applied to the indicators 621 and 622.

FIG. 7B illustrates a smart watch. The smart watch can include a housing 702, a display panel 704, operation buttons 711 and 712, a connection terminal 713, a band 721, a clasp 722, and the like.

The display panel 704 mounted in the housing 702 serving as a bezel includes a non-rectangular display region. The display panel 704 can display an icon 705 indicating time, another icon 706, and the like.

The smart watch in FIG. 7B can have a variety of functions, for example, a function of displaying a variety of information (e.g., a still image, a moving image, and a text image) on a display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading program or data stored in a recording medium and displaying the program or data on a display portion.

The housing 702 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like.

The structure described in this embodiment can be used in appropriate combination with the structure described in any of the other embodiments.

This application is based on Japanese Patent Application serial no. 2013-042518 filed with Japan Patent Office on Mar. 5, 2013, the entire contents of which are hereby incorporated by reference.

What is claimed is:

1. A display device comprising:
a display region comprising a pixel, the display region including a non-rectangular shape; and
a driver circuit portion on a periphery of the display region, the driver circuit portion comprising:
a first gate driver and a second gate driver apart from each other; and
a first source driver and a second source driver apart from each other.

2. The display device according to claim 1, wherein the first gate driver faces the second gate driver.

3. The display device according to claim 1, wherein the first source driver faces the second source driver.

4. The display device according to claim 1,
wherein the first source driver is configured to input signals to a first region of the display region, and
wherein the second source driver is configured to input signals to a second region of the display region.

5. The display device according to claim 1, wherein the display region includes inwardly dented shapes or includes a rectangular portion and a circular portion.

6. The display device according to claim 1, wherein a shape of a pixel electrode of the pixel includes an arc in accordance with the non-rectangular shape of the display region.

7. An electronic device comprising the display device according to claim 1.

8. A display device comprising:
a display region comprising a pixel, the display region including a non-rectangular shape;
a driver circuit portion on a periphery of the display region, the driver circuit portion comprising:
a first gate driver and a second gate driver apart from each other; and
a first source driver and a second source driver apart from each other; and
a protection circuit between the display region and the driver circuit portion.

9. The display device according to claim 8, wherein the first gate driver faces the second gate driver.

10. The display device according to claim 8, wherein the first source driver faces the second source driver.

11. The display device according to claim 8,
wherein the first source driver is configured to input signals to a first region of the display region, and
wherein the second source driver is configured to input signals to a second region of the display region.

12. The display device according to claim 8, wherein the display region includes inwardly dented shapes or includes a rectangular portion and a circular portion.

13. The display device according to claim 8, wherein a shape of a pixel electrode of the pixel includes an arc in accordance with the non-rectangular shape of the display region.

14. An electronic device comprising the display device according to claim 8.

15. A display device comprising:
a display region comprising a pixel, the display region including a non-rectangular shape; and
a driver circuit portion on a periphery of the display region, the driver circuit portion comprising:
a first gate driver and a second gate driver apart from each other; and
a first source driver and a second source driver apart from each other,
wherein the first gate driver is positioned along a first part of an outer edge of the display region,
wherein the second gate driver is positioned along a second part of the outer edge of the display region,
wherein the first source driver is positioned along a third part of the outer edge of the display region, and
wherein the second source driver is positioned along a fourth part of the outer edge of the display region.

16. The display device according to claim 15, wherein the first gate driver faces the second gate driver.

17. The display device according to claim 15, wherein the first source driver faces the second source driver.

18. The display device according to claim 15,
wherein the first source driver is configured to input signals to a first region of the display region, and
wherein the second source driver is configured to input signals to a second region of the display region.

19. The display device according to claim 15, wherein the display region includes inwardly dented shapes or includes a rectangular portion and a circular portion.

20. The display device according to claim 15, wherein a shape of a pixel electrode of the pixel includes an arc in accordance with the non-rectangular shape of the display region.

21. An electronic device comprising the display device according to claim 15.
